(19) United States
(12) Patent Application Publication
(10) Pub. No.: US 2013/0170434 A1
(43) Pub. Date: Jul. 4, 2013

(54) COMMUNICATION MODE SELECTION METHOD AND DEVICE

(71) Applicant: Huawei Device Co., Ltd., Shenzhen (CN)

(72) Inventors: Kaibing ZHANG, Xi'an (CN); Guangze ZHU, Xi'an (CN); Zehui SUN, Shenzhen (CN); Xinchao SHUI, Xi'an (CN)

(73) Assignee: HUAWEI DEVICE CO., LTD., Shenzhen (CN)

(21) Appl. No.: 13/663,199

(22) Filed: Oct. 29, 2012

(30) Foreign Application Priority Data
Dec. 30, 2011 (CN) 201110455718.6

(51) Int. Cl. H04W 8/22

(52) U.S. Cl. CPC H04W 8/22
USPC 370/328

(57) ABSTRACT

The present invention provides a communication mode selection method, which includes: when a state parameter of a communication terminal meets a predetermined condition, selecting a mode corresponding to a spatial multiplexing technique as a mode for communication between the terminal and a corresponding base station, where the predetermined condition at least includes that the number of antennas is greater than 1. This prevents the terminal from entering a MIMO B mode in the case of using a single antenna, so that repeated switching between a MIMO A mode and the MIMO B mode may not occur, and therefore, the problem of service jittering caused by repeated switching is avoided.

### CROSS-REFERENCE TO RELATED APPLICATIONS

This application claims priority to Chinese Patent Application No. 201110455718.6, filed on Dec. 30, 2011, which is hereby incorporated by reference in its entirety.

### FIELD OF THE INVENTION

The present invention relates to the field of communications, and in particular, to a communication mode selection method and device.

### BACKGROUND OF THE INVENTION

In recent years, a multiple-input multiple-output (Multiple-Input Multiple-Out-put, MIMO) technique has emerged as a new technique in the field of wireless communications. The MIMO technique includes a spatial diversity technique and a spatial multiplexing technique, a communication mode using the spatial diversity technique is named as a MIMO A mode, and a communication mode using the spatial multiplexing technique is named as a MIMO B mode, in which the MIMO B mode truly embodies an essential advantage that the data capacity of the MIMO technique is high. General conditions of using the MIMO B mode are that a modulation and demodulation method of a terminal in a current working mode is 64QAM-CTC-5/6, that is, a highest uplink or downlink order method, and a bit error rate is within a range (less than 5%) or no bit error occurs under the highest order.

When it is detected by a base station that a terminal meets the conditions of using the MIMO B mode, the terminal is switched to the MIMO B mode, and according to the working principle of the MIMO B mode, signals transmitted by different antennas of the base station include different information. However, if a single antenna is currently adopted to receive data, in this working mode, a receiving antenna can only receive part of the information and lose part of the information, resulting in that bit errors occur to all received data packets eventually. In this case, the base station switches the terminal back to the MIMO A mode according to a high bit error rate, and when it is detected by the terminal or the base station again that the terminal meets the conditions of switching to the MIMO B mode, the terminal is switched to the MIMO B working mode again, resulting in that bit errors occur to all data packets received by the terminal and the terminal is switched back to the MIMO A mode again. Such repeated switching may cause jittering of a communication service.

### SUMMARY OF THE INVENTION

Accordingly, the present invention provides a communication mode selection method and device, so as to solve the problem of jittering of a communication service caused by repeated switching of working modes while a multiple-input multiple-output technique is used.

A communication mode selection method includes:

obtaining a current state parameter of a terminal, the state parameter at least including the number of antennas currently used by the terminal; and

selecting a mode corresponding to a spatial multiplexing technique as a mode for communication between the terminal and a corresponding base station when the state parameter meets a predetermined condition, the predetermined condition at least including that the number of the antennas is greater than 1.

A communication mode selection device includes:

a state parameter obtaining module, configured to obtain a current state parameter of a terminal; and

a communication mode selection module, configured to select a mode corresponding to a spatial multiplexing technique as a mode for communication between the terminal and a corresponding base station when the state parameter meets a predetermined condition, the predetermined condition at least including that the number of antennas is greater than 1.

The communication mode selection method and device provided by the embodiments consider the number of receiving or transmitting antennas currently used by the terminal as a necessary condition for determining whether the MIMO B mode is used for communication between the terminal and the base station; and entering the MIMO B mode is rejected if the number of the receiving antennas is 1, which prevents the terminal from entering the MIMO B mode in the case of using a single antenna, so that repeated switching between the MIMO A mode and the MIMO B mode may not occur, and therefore, the problem of service jittering caused by repeated switching is avoided.

### BRIEF DESCRIPTION OF THE DRAWINGS

To illustrate the technical solutions in the embodiments of the present invention or in the prior art more clearly, the accompanying drawings needed for describing the embodiments or the prior art are introduced below briefly. Apparently, the accompanying drawings in the following descriptions merely show some of the embodiments of the present invention, and persons skilled in the art may obtain other drawings according to the accompanying drawings without creative efforts.

FIG. 1 is a flow chart of a communication mode selection method provided by an embodiment of the present invention;

FIG. 2 is a flow chart of a method for obtaining a state parameter of a terminal in a communication mode selection method provided by an embodiment of the present invention; and

FIG. 3 is a schematic structural diagram of a communication mode selection device provided by an embodiment of the present invention.

### DETAILED DESCRIPTION OF THE EMBODIMENTS

The present invention provides a communication mode selection method and device, which consider the number of antennas currently used by a terminal as one of conditions for selecting a communication mode between the terminal and a base station, and when the number of the antennas is greater than 1, it is possible for the terminal to select a mode corresponding to a spatial multiplexing technique for communication.

The technical solutions of the embodiments of the present invention are hereinafter described clearly and completely with reference to the accompanying drawings in the embodiments of the present invention. Evidently, the described embodiments are some exemplary embodiments of the present invention, rather than all embodiments of the present invention. All other embodiments obtained by persons skilled in the art based on the embodiments of the present invention without creative effects shall fall within the protection scope of the present invention.

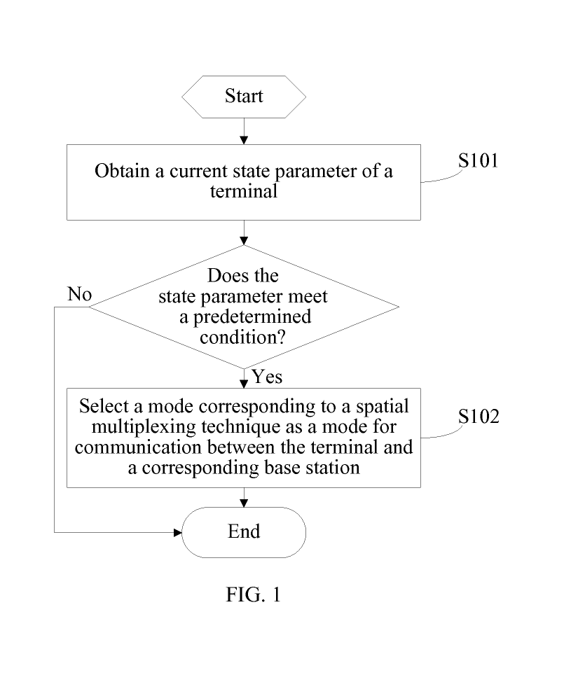

A communication mode selection method is provided by the present invention, and as shown in FIG. 1, the method includes the following steps:

S101: Obtain a current state parameter of a terminal, the state parameter at least including the number of antennas currently used by the terminal.

The antennas currently used by the terminal may be receiving antennas, and may also be transmitting antennas.

S102: Select a mode corresponding to a spatial multiplexing technique as a mode for communication between the terminal and a corresponding base station, when the state parameter meets a predetermined condition, the predetermined condition at least including that the number of the antennas is greater than 1.

It should be noted that, for the base station, the receiving antennas and the transmitting antennas may be different, and the modes for uplink communication and downlink communication may also be different. When the receiving antennas are currently used by the terminal, it means that downlink communication is implemented between the terminal and the base station, and a mode corresponding to the spatial multiplexing technique is selected as a mode for communication between the terminal and the base station when the number of the receiving antennas is greater than 1. On the contrary, when the transmitting antennas are currently used, it means that uplink communication is implemented between the terminal and the base station, and a mode corresponding to the spatial multiplexing technique is selected as a mode for communication between the terminal and the base station when the number of the transmitting antennas is greater than 1.

The communication mode selection method provided by the embodiment considers the number of the antennas currently used by the terminal as a necessary condition for selecting the communication mode between the terminal and the base station, and only when the number of the antennas is greater than 1, that is, not only one antenna is currently used, a MIMO B mode may be selected for communication. In other words, entering the MIMO B mode is rejected when the terminal currently uses a single antenna, which avoids service jittering caused by using a single antenna in the MIMO B mode, and enhances user experience of the MIMO technique.

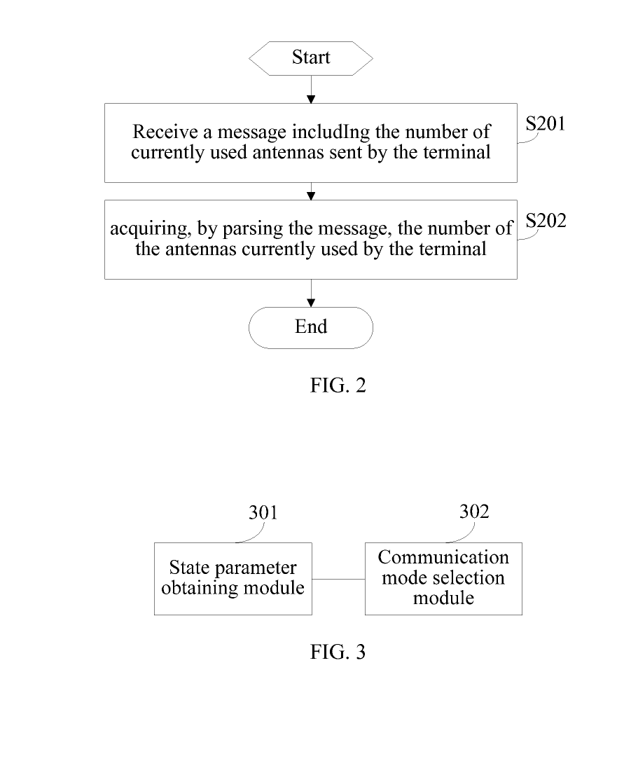

Further, as shown in FIG. 2, the obtaining the current state parameter of the terminal in the embodiment includes the following steps:

S201: Receive a message including the number of currently used antennas sent by the terminal.

The message may be in the following format:

| | | | | |
|---|---|---|---|---|
| Name | Type | Length | Value | PHY |
| | (1 byte) | | (variable- | Scope |
| | | | length) | |

Type is a newly added field, used for defining the number of antennas used by the terminal. The length of Type may be one byte, lower four bits represent the number of receiving antennas, and higher four bits represent the number of transmitting antennas.

S202: acquiring, by parsing the message, the number of the antennas currently used by the terminal.

The terminal may actively report the number of used antennas in a method of reporting according to a predetermined cycle or in a method of reporting when the number of the used antennas changes. The embodiment is not limited thereto, and no matter which method is adopted, the number of the antennas can be acquired accurately.

Further, according to different application scenarios, the method of the embodiment is further divided into the following two implementation ways:

1. On the basis of having determined that the MIMO B mode may be used by the terminal for communication, the method includes:

obtaining the number of the antennas currently used by the terminal; and

selecting a mode corresponding to the spatial multiplexing technique as a mode for communication between the terminal and the corresponding base station when the number of the antennas is greater than 1.

2. Consider the number of the antennas as one of judging conditions for selecting the MIMO B mode, and the method includes:

obtaining the number of the antennas currently used by the terminal, a currently used modulation and demodulation method and a current bit error rate; and

when the number of the antennas is greater than 1, the currently used modulation and demodulation method is a highest uplink or downlink order, i.e., 64QAM-CTC-5/6, and the bit error rate of the highest order is less than a predetermined value, selecting a mode corresponding to the spatial multiplexing technique as a mode for communication between the terminal and the corresponding base station.

It should be noted that, the preceding three judging conditions, that is, the number of the antennas being greater than 1, the modulation and demodulation method being 64QAM-CTC-5/6, and the bit error rate being less than the predetermined value, are not limited to any precedence order, and if any one of the three conditions is not met, the MIMO B mode is not selected as the mode for communication between the terminal and the base station.

It may be seen from the above two implementation ways that the method of the present invention may be implemented after or before the determination that the terminal may select the MIMO B mode. When it is determined that the number of the antennas is less than 1, it is not necessary to judge whether the other conditions are met.

It should be noted that, the method of the present invention is applicable to both the terminal and the base station. When the method is used for the terminal, after the determination of selecting the MIMO B mode, the terminal further reports a result to the base station.

In accordance to the preceding method, the present invention further provides a communication mode selection device, and as shown in FIG. 3, the device includes:

a state parameter obtaining module 301, configured to obtain a current state parameter of a terminal; and

a communication mode selection module 302, configured to select a mode corresponding to a spatial multiplexing technique as a mode for communication between the terminal and a corresponding base station when the state parameter meets a predetermined condition, the predetermined condition at least including that the number of the antennas is greater than 1.

Further, the state parameter obtaining module includes:

a receiving unit, configured to receive a message including the number of the currently used antennas sent by the terminal; and

a parsing unit, configured to parse the number of the antennas used by the terminal from the message.

The communication mode selection device described by the embodiment is applicable to both a mobile communication terminal and a base station, and considers the number of the antennas currently used by the terminal as a necessary condition for selecting the MIMO B mode, which avoids service jittering caused by the terminal entering the MIMO B mode in the case of using a single antenna. When the device is used for the mobile communication terminal, the result of the selection is reported to the corresponding base station. A reporting process is the same as the existing process of reporting information to the base station by the terminal, so the details are not repeated here.

Each embodiment describes the present invention by using a progressive method. Each embodiment focuses on the difference from the other embodiments. For the same or similar parts among all the embodiments, reference may be made to the relevant parts.

The preceding description disclosed in the embodiments allows a person skilled in the art to implement or use the present invention. Multiple modifications to these embodiments are apparent for a person skilled in the art. The general principle defined in the present invention may be implemented in other embodiments without departing from the spirit or scope of the present invention. Therefore, the present invention is not limited to the embodiments described in the document but extends to the widest scope that complies with the principle and novelty disclosed in the document.

What is claimed is:

1. A communication mode selection method, comprising:
obtaining a current state parameter of a terminal, the state parameter at least comprising the number of antennas currently used by the terminal; and
selecting a mode corresponding to a spatial multiplexing technique as a mode for communication between the terminal and a corresponding base station when the state parameter meets a predetermined condition, the predetermined condition at least comprising that the number of the antennas is greater than 1.

2. The method according to claim 1, wherein the obtaining the current state parameter of the terminal comprises:
receiving a message comprising the number of currently used antennas sent by the terminal; and
acquiring, by parsing the message, the number of the antennas currently used by the terminal.

3. The method according to claim 1, wherein the number of the antennas comprises:
the number of receiving antennas or the number of transmitting antennas.

4. The method according to claim 3, wherein when the number of the antennas is the number of the receiving antennas, the selecting a mode corresponding to a spatial multiplexing technique as a mode for communication between the terminal and a corresponding base station comprises:
selecting a mode corresponding to the spatial multiplexing technique as a mode for downlink communication between the terminal and the corresponding base station.

5. The method according to claim 3, wherein when the number of the antennas is the number of the transmitting antennas, the selecting a mode corresponding to a spatial multiplexing technique as a mode for communication between the terminal and a corresponding base station comprises:
selecting the spatial multiplexing technique as a mode for uplink communication between the terminal and the corresponding base station.

6. The method according to claim 1, wherein the state parameter further comprises:
a current modulation and demodulation method and a bit error rate of the terminal.

7. The method according to claim 6, wherein the predetermined condition further comprises that:
the current modulation and demodulation method of the terminal is a highest order method, and the bit error rate is less than a predetermined value.

8. A communication mode selection device, comprising:
a state parameter obtaining module, configured to obtain a current state parameter of a terminal; and
a communication mode selection module, configured to select a mode corresponding to a spatial multiplexing technique as a mode for communication between the terminal and a corresponding base station when the state parameter meets a predetermined condition, the predetermined condition at least comprising that the number of antennas is greater than 1.

9. The device according to claim 8, wherein the state parameter obtaining module comprises:
a receiving unit, configured to receive a message containing the number of currently used antennas sent by the terminal; and
a parsing unit, configured to acquiring, by parsing the message, the number of the antennas currently used by the terminal.

10. The device according to claim 8, wherein the device is applicable to a base station or a mobile communication terminal.
